(19) United States
(12) Patent Application Publication
(10) Pub. No.: US 2018/0240022 A1
(43) Pub. Date: Aug. 23, 2018

(54) SYSTEM AND METHOD FOR PREDICTIVE OID FIELD IDENTIFICATION

(71) Applicants: Kabushiki Kaisha Toshiba, Minato-ku (JP); Toshiba TEC Kabushiki Kaisha, Shinagawa-ku (JP)

(72) Inventors: Jonathan Channa, Rancho Cucamonga, CA (US); Surya Ravichandran, Mission Viejo, CA (US)

(21) Appl. No.: 15/440,212

(22) Filed: Feb. 23, 2017

(51) Int. Cl. G06N 5/04; G06N 99/00

(52) U.S. Cl. CPC G06N 5/04; G06N 99/005

(57) ABSTRACT

A system and method for predictive object identifier (OID) field identification for multifunction peripherals includes a processor configured to walk the managed information base (MIB) of a multifunction peripheral having unidentified OIDs, and save simple network management protocol (SNMP) data associated with the unidentified OIDs to a database. A machine learning process compares data associated with the unidentified OIDs with training data derived from prior training of the machine learning process to predict one or more candidate OID field types for one or several unidentified OIDs. One of the candidate OID field types can be selected by a user as the predicted OID field type, and the selection can be used to improve the training of the machine learning process. The machine learning process can be trained using data derived from walking the MIB of a plurality of multifunction peripherals having known MIBs and OIDs.

### TECHNICAL FIELD

This application relates generally to a system and method for determining object identifier (OID) information for a management information base (MIB) of a multifunction peripheral (MFP) using the simple network management protocol (SNMP). The application relates more particularly to analyzing changes in OID information queried from third party MFPs to predict the type of data stored in OID fields when the MIB of the MFP is not known.

### BACKGROUND

Document processing devices include printers, copiers, scanners, fax machines, and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Given the expense in obtaining and maintain MFPs, MFPs are frequently shared by users and monitored by technicians via a data network. MFPs can be monitored using the Simple Network Management Protocol (SNMP). Each brand or model of MFP monitored via SNMP includes a management information base (MIB) with multiple Object Identifiers (OIDs) that define each kind of data on the MFP that can be monitored. Example OIDs can include data such a counters, paper usage, color printing, toner levels and so forth.

Generally, the MIB for a particular type of MFP must be known in advance, for example by referring to a specification provided by the MFP manufacturer. Monitoring third party MFPs via SNMP without a specification or the MIB can be performed, but reliably determining information such as specific counter information from the MFP generally requires knowing which OID in the MIB is associated with the desired information.

### SUMMARY

In accordance with an example embodiment of the subject application, a system includes a database, a machine learning system, and a device controller, for example a device controller of a document processing system or multifunction peripheral. The device controller is configured to walk the MIB of a document processing system to obtain SNMP data having a number of unidentified OIDs. The device controller stores the SNMP data to a database. The SNMP data can be retrieved from the database, and data associated with OIDs can be extracted, formatted into a format suitable for a machine learning system, and stored in the database. The machine learning system can be configured to predict one or several possible OID types for one or more of the unidentified OIDs. Example OID types can include, but are not limited to, a count of printed pages such as black and white, color, or total pages, an indication of a paper level in a paper tray, for example empty or paper present, a toner level, and an error indication among other OID types. The machine learning system can predict OID type based on data associated with the OID or changes in the data associated with an OID, such as changing page counts. The machine learning system can generate the training data by walking the MIB of one or several document processing system having known MIBs and OIDs. A user interface on one or the system components or on a separate system can display predicted OID types for an unknown OID, receive a user selection of one of the OID types via an input, and save the predicted OID type to a database. The predicted OID type can be used to update the training data to improve future predictions by the machine learning system.

### BRIEF DESCRIPTION OF THE DRAWINGS

Various embodiments will become better understood with regard to the following description, appended claims and accompanying drawings wherein:

FIG. 1 is a system overview diagram of a system for predictively determining Object Identifier (OID) type of a third party MFP according to an embodiment of the disclosure;

FIG. 2 is a diagram of example components of a multifunction peripheral according to an embodiment of the disclosure;

FIG. 3 is a diagram of example components of a computing device according to an embodiment of the disclosure;

FIG. 4 is a flow diagram of example operations of the SNMP Data Collection Agent (DCA) according to an embodiment of the disclosure;

FIG. 5 is a flow diagram of example operations for predictively determining OID field type according to an embodiment of the disclosure; and

FIG. 6 is a flow diagram of example operations for determining OID field type using a published specification according to an embodiment of the disclosure.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

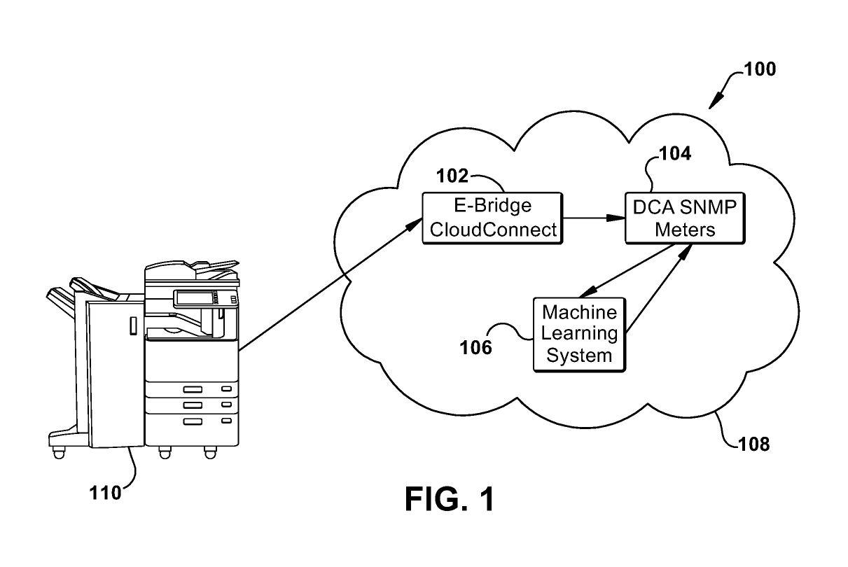

Referring now to FIG. 1, a system 100 for predictively determining SNMP MIB OID information of an MFP 110 includes a data collection agent or DCA 102, cloud storage 104, and a machine learning system 106. The DCA 102, cloud storage 104, and machine learning system 106 communicate over a network 108, such as a wired or wireless local area network, a wide area network, the Internet, or any suitable network as would be understood in the art. The DCA 102 can be an MFP executing E-Bridge Cloud Connect as shown in FIG. 1. Cloud storage 104 can include suitable storage systems such as a SQL or search and query language database, and other local or network accessible storage as would be understood in the art. The machine learning system 106 can be a separate server, a process executing on a device such as an MFP, or a network service provided by a third party service provider as would be understood in the art.

In the system 100, the DCA 102 walks the MIB of the MFP 110, and stores retrieved MIB and OID data in cloud storage 104. As the MFP 110 is used, the DCA 102 receives additional OID data from the MFP 110. The data in one or more of the OIDs will change as the MFP 110 is used. For example, for an OID associated with the number of pages printed by the MFP, data associated with the OID will include a number that increments as the MFP 110 is used. The machine learning system 106 can monitor changes in the OID data and use models to predictively determine which OIDs are associated with certain kinds of data, such as counters, page counts, paper and toner levels, and so forth. The machine learning system 106 can store predictions in the cloud storage 104, and the predictions can be curated by technicians. Once the identity of an OID is determined, for example by prediction and curation, the stored date for the OID can be associated with the corresponding counter, page count, paper levels, and so forth and used to manage the MFP 110.

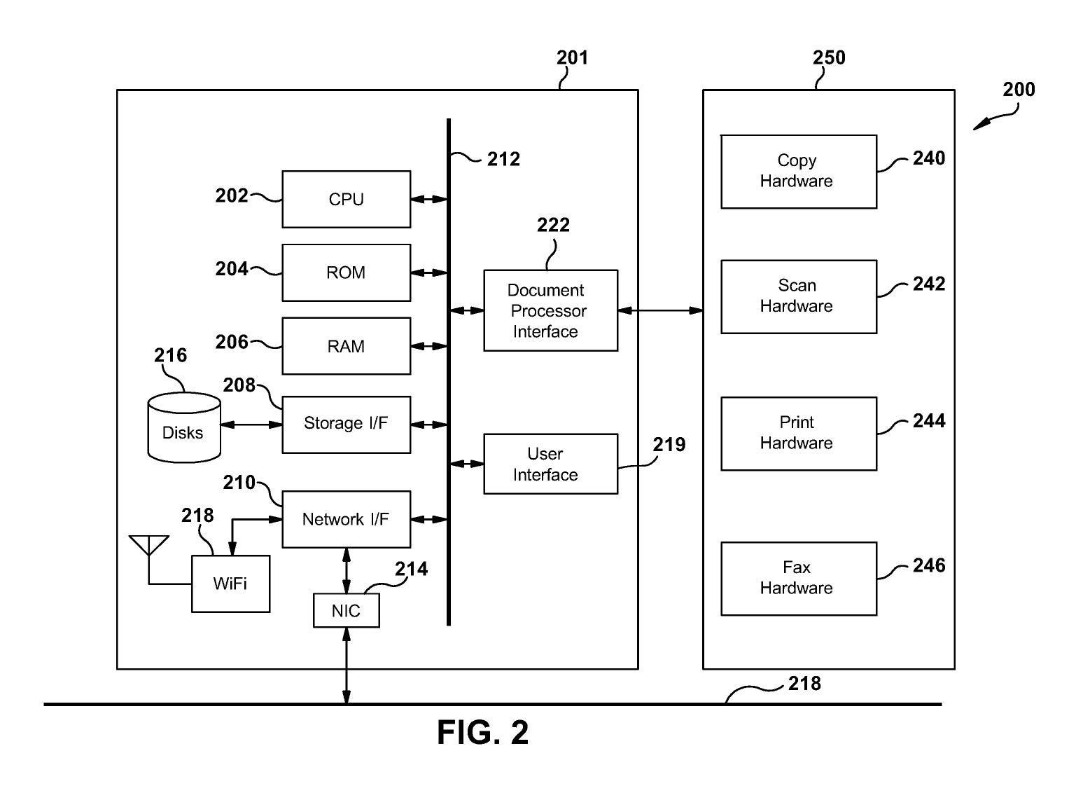

Turning now to FIG. 2, illustrated is an example embodiment of a document rendering system 200 suitably comprised within an MFP, such as with MFP 110 of FIG. 1. Included in controller 201 are one or more processors, such as that illustrated by processor 202. Each processor is suitably associated with non-volatile memory, such as ROM 204, and random access memory (RAM) 206, via a data bus 212. Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 218 or to a wireless data connection via wireless network interface 220. Example wireless connections include cellular, Wi-Fi, BLUETOOTH, NFC, wireless universal serial bus (wireless USB), satellite, and the like. Example wired interfaces include Ethernet, USB, IEEE 1394 (FireWire), LIGHTNING, telephone line, or the like.

Processor 202 can also be in data communication with any suitable user input/output (I/O) interface 219 which provides data communication with user peripherals, such as displays, keyboards, mice, track balls, touchscreens, or the like. Also in data communication with data bus 212 is a document processor interface 222 suitable for data communication with MFP functional units 250. In the illustrate example, these units include copy hardware 240, scan hardware 242, print hardware 244 and fax hardware 246 which together comprise MFP functional hardware 250. It will be understood that functional units are suitably comprised of intelligent units, including any suitable hardware or software platform.

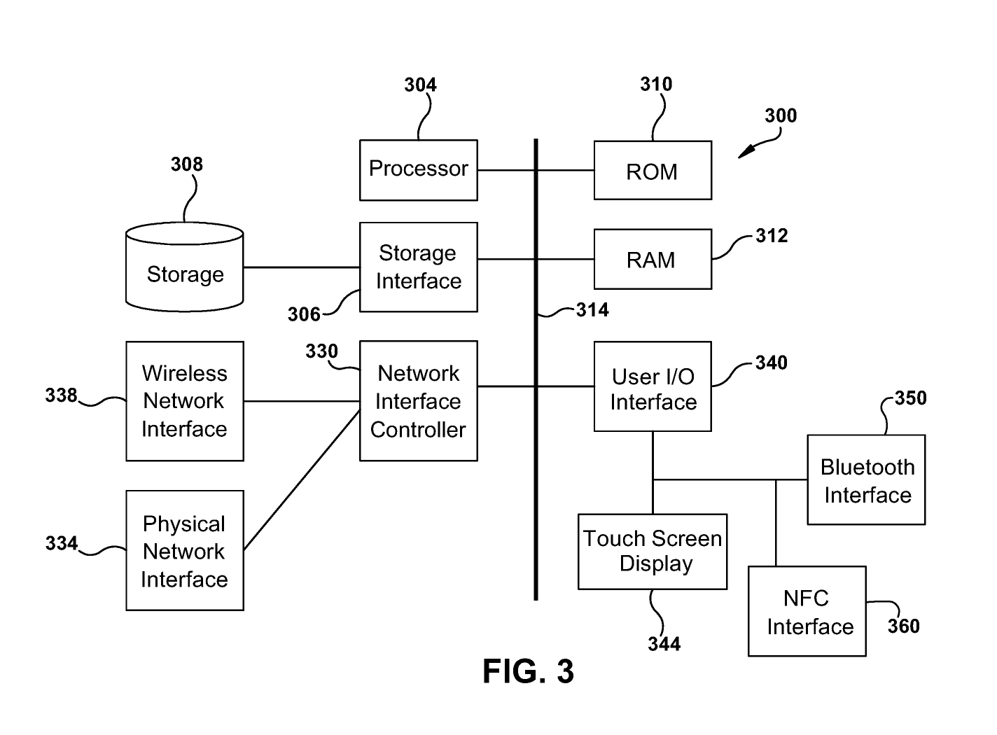

Turning now to FIG. 3, illustrated is an example embodiment 300 of digital devices such as the DCA 102, the cloud storage 104, or the machine learning system 106, and which architecture is suitably implemented in a document processing device such as an MFP controller. Included are one or more processors, such as that illustrated by processor 304. Each processor is suitably associated with non-volatile memory, such as read only memory (ROM) 310 and random access memory (RAM) 312, via a data bus 314.

Processor 304 is also in data communication with a storage interface 316 for reading or writing to a data storage system 318, suitably comprised of a hard disk, optical disk, solid-state disk, or any other suitable data storage as will be appreciated by one of ordinary skill in the art.

Processor 304 is also in data communication with a network interface controller (NIC) 330, which provides a data path to any suitable wired or physical network connection via physical network interface 334, or to any suitable wireless data connection via wireless network interface 338, such as one or more of the networks detailed above.

Processor 304 is also in data communication with a user input/output (I/O) interface 340 which provides data communication with user peripherals, such as display 344, as well as keyboard 350, mouse 360 or any other interface, such as track balls, touchscreens, or the like. It will be understood that functional units are suitably comprised of intelligent units, including any suitable hardware or software platform.

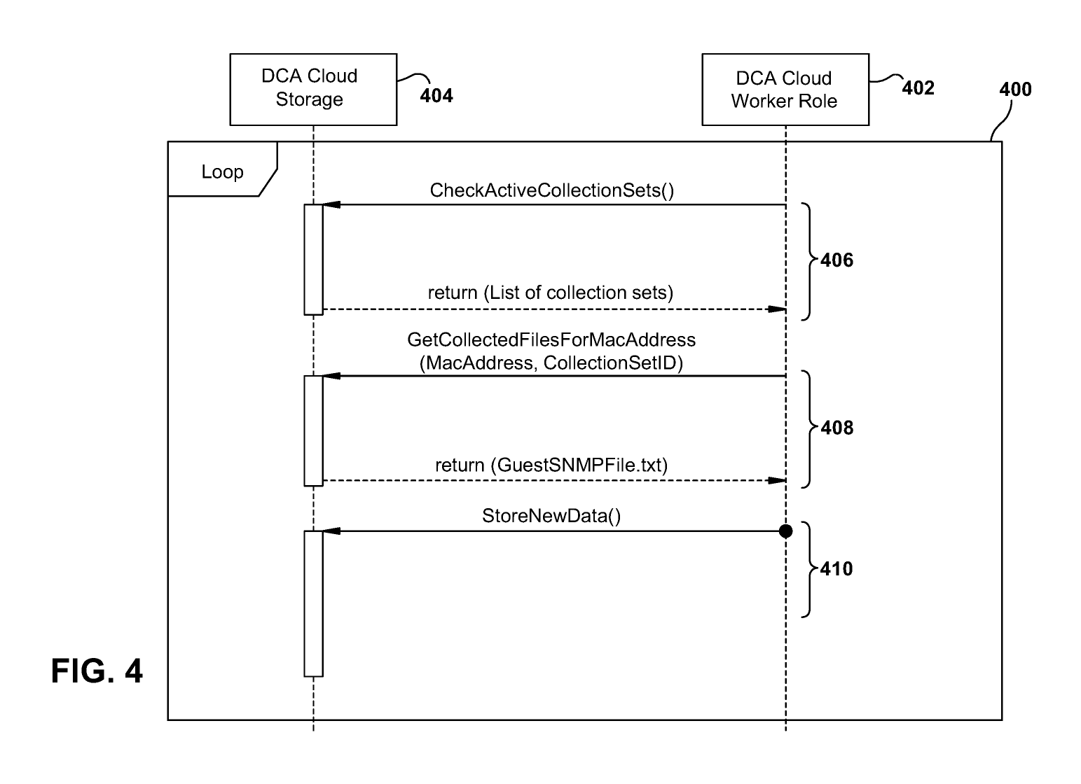

Referring now to FIG. 4, example operations of the Data Collection Agent (DCA 402) are illustrated. The DCA 402 can retrieve collection sets 406 from DCA cloud storage 404. The DCA 402 can retrieve SNMP files 408, for example a comma separated value (CSV) text file for an MFP, from the DCA cloud storage 404. The DCA 402 can store new data 410 to the DCA cloud storage 404. The retrieving and storing operations can continue in a loop. In this way, the DCA 402 can continuously retrieve and update data as new MFPs are discovered or added to the system, and as data changes in the OIDs of the MFPs.

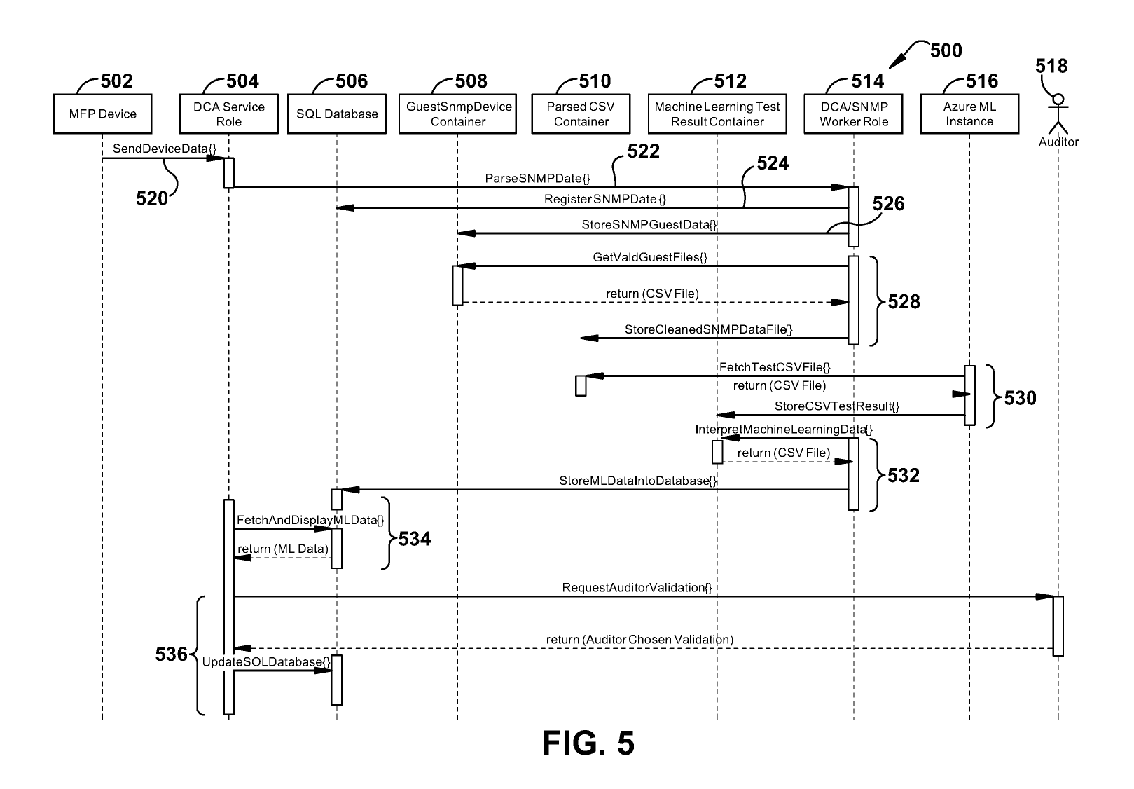

Referring now to FIG. 5, example operations 500 for predictively determining OID field types are presented. Initially, the operations 500 can be used to train the machine learning system 516 using known MIBs and OIDs of one or several different MFPs 502. Once the machine learning system 516 is trained, the operations 500 can be used to predictively determine OID field types for third party MFPs having undocumented or unknown MIBs and OID fields. The results determined by the machine learning system 516 can be verified by a user auditor 518.

At step 520, data is collected from an MFP 502 by a DCA service agent 504. For example, the MFP 502 can report data to the DCA service agent 504, or the DCA service agent 504 can perform a MIB walk of the MFP 502 to obtain the data. The DCA service agent 504 parses the SNMP data at step 522 and sends the parsed SNMP data to the DCA worker agent 506. A DCA worker agent 506 receives the parsed SNMP data and registers the SNMP data at step 524 in an SQL database. The DCA worker agent 506 stores the SNMP data as Guest SNMP data at step 526 in a Guest SNMP Device Container 508. In step 528, the DCA worker agent 506 accesses the Guest SNMP Device Container 508, receives a CSV data file of the data, and stores the CSV data file in a Parsed CSV Container 510.

In step 530, the machine learning system 516 retrieves the CSV data file from the Parsed CSV Container 510, performs machine learning tests, and stores a test result in a Machine Learning Test Result Container 512. In step 532, the DCA worker agent 506 interprets the stored test result from the Machine Learning Test Result Container 512 and stores the machine learned data to the SQL Database 506. In step 534, the DCA service agent 504 can fetch and display the machine learned data from the SQL Database 506. In step 536, the DCA worker agent 504 can send machine learned data to an auditor 518 for validation, and the DCA worker agent 504 can update the SQL database 506 based on the validation selection from the auditor 518.

Initially training the machine learning system 616 can be accomplished using the same operations 500. The DCA service agent 504 performs a MIB walk of an MFP 502 with known OID field types. The machine learning system 616 learns the patterns and trends of the known OID field types. For example, counters increase predictably as toner levels correspondingly decrease at a somewhat different rate. Sums of various counters have a direct correlation, for example the total page count is the sum of color page count and black-at-white page count. Similarly, total pages count is the sum of paper counters for each size of paper. Counters can have identifiable ranges. Some counters define slopes and can remain constant over long periods of use. Field descriptions can often be found in neighboring OID trees to facilitate machine learning identification.

When trained, the machine learning system 616 can match the data retrieved from MIB walks of new MFPs with previously learned OID field types. The machine learning system 616 can determine the most probable OID field type or OID field types that best match the data. High probability matches can be stored and displayed to a user auditor 518. The user auditor 518 can confirm results that appear to be correctly identified, or can deny results that are false positives or are incorrectly predicted. The feedback from the user auditor 518 is saved to the SQL database 506 and can be applied to OIDs of similar models in future testing.

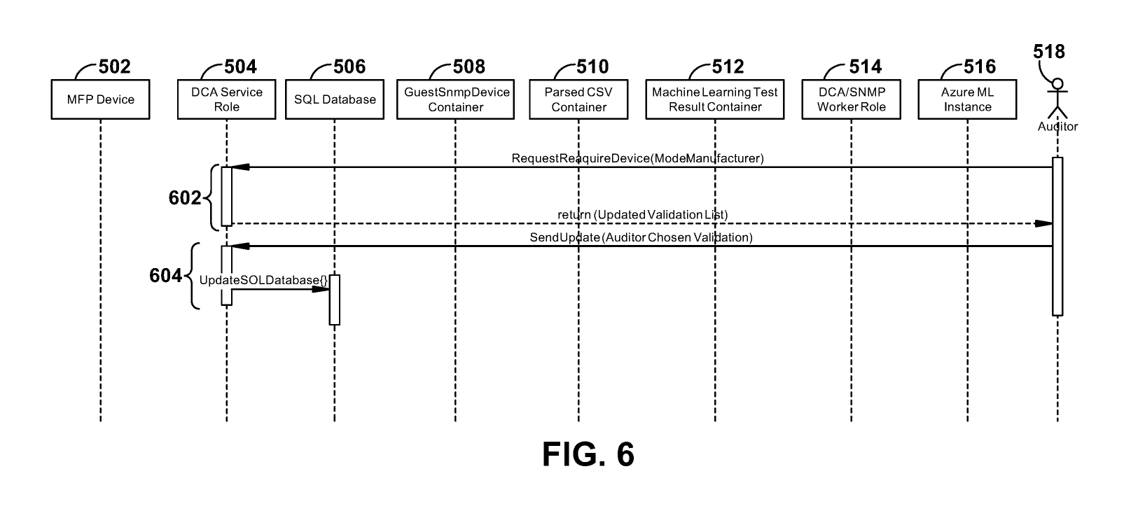

Referring to FIG. 6, example operations 600 for entering OID field types are presented. The OIDs and MIB are entered into the database from a specification provided by the third party manufacturer of the MFP 502, rather than obtained via a MIB walk of the MFP 502. In the step 602, the user curator 518 initiates the process and receives OID information for verification. In step 604, the user curator 518 validates the OID information and the SQL database is updated accordingly.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
a database;
a device controller including a processor, a memory, and a network interface, configured to
perform a managed information base (MIB) walk on a document processing device via the network interface and obtain simple network management protocol (SNMP) data having a plurality of unidentified object identifiers (Ms), and
store the SNMP data to the database; and
a machine learning system configured to predict at least one OID type of one or more of the unidentified OIDs.

2. The system of claim 1, wherein the machine learning system is configured to predict at least one OID type of an unidentified OID by comparing data associated with the unidentified OID with training data.

3. The system of claim 2, wherein the machine learning systems is configured to predict the at least one OID type based at least in part on changes over time of the data associated with the unidentified OID.

4. The system of claim 2, wherein the machine learning system is configured to generate the training data from each MIB walk of one or more document processing systems having known MIBs and OIDs.

5. The system of claim 2, further comprising:
a user interface configured to
display the one or more predicted OID types for an unknown OID,
monitor an input associated with the user interface for a user selection of one of the predicted OID types; and
save the predicted OID type of the OID to the database based on the user selection.

6. The system of claim 5, wherein the training data is updated based at least in part on the user selection of the predicted OID type of the OID.

7. The system of claim 1, wherein each OID type is selected from the group consisting of a count of printed pages, an indication of a paper level in a paper tray, a toner level, and an error indication.

8. The system of claim 1, further comprising:
a multifunction peripheral comprising the device controller.

9. The system of claim 1, further comprising:
a second processor configured to
retrieve the SNMP data from the database,
extract data associated with OIDs into a format suitable for use by the machine learning system, and
store the extracted data in the database.

10. A method comprising:
performing a managed information base (MIB) walk on a multifunction peripheral to obtain simple network management protocol (SNMP) data having a plurality of object identifiers (OIDs); and
predicting an OID type of at least one of the plurality of OIDs based at least in part on data associated with each OID.

11. The method of claim 10, wherein the MIB walk is performed by a second multifunction peripheral.

12. The method of claim 10, wherein the predicting is based on changes over time of the data associated with one or more OIDs.

13. The method of claim 12, further comprising comparing the changes over time of the data with training data derived at least in part from a MIB walk of a second multifunction peripheral having a known MIB and known OIDs.

14. The method of claim 13, further comprising:
training a machine learning process using SNMP data from the second multifunction peripheral with a known MIB, and
saving the training data into a database.

15. The method of claim 14, further comprising:
displaying, via a user interface, one or more predicted OID types in the database for an OID in the MIB of the multifunction peripheral;
monitoring an input associated with the user interface for a user selection of one of the predicted OID types; and
saving an OID type of the OID to the database based on the user selection.

16. The method of claim 15, further comprising:
updating the training data based at least in part on the user selection of OID type of the OID.

17. A document processing device, comprising:
a device controller including a processor and memory; and
a network interface,
wherein the processor is configured to
perform a managed information base (MIB) walk on a second document processing device via the network interface to obtain SNMP data having a plurality of unidentified object identifiers (OIDs),
save data associated with the unidentified OIDs to a database, and
receive a predicted OID type of at least one of the plurality of unidentified OIDs based at least in part on data associated with each OID in the database.

18. The document processing device of claim 17, wherein the processor is further configured to receive additional SNMP data that includes predicted OIDs and save the SNMP data to the database.

19. The document processing device of claim 17, wherein a MIB and associated OIDs of the second document processing device are unknown when the MIB walk is performed, and wherein a machine learning process compares the data associated with one or more of the OIDs in the database with training data to predict the OID type of at least one of the OIDs.

20. The document processing device of claim 17, wherein the predicted OID type is selected from the group consisting of a count of printed pages, an indication of a paper level in a paper tray, a toner level, and an error indication.
